(19) United States
(12) Patent Application Publication
(10) Pub. No.: US 2014/0361576 A1
(43) Pub. Date: Dec. 11, 2014

(54) MOTOR-VEHICLE DOOR

(71) Applicant: C.R.F. SOCIETÁ CONSORTILE PER AZIONI, Orbassano (Torino) (IT)

(72) Inventors: Angelo Storgato, Orbassano (Torino) (IT); Giorgio Masoero, Orbassano (Torino) (IT); Andrea Caroli, Orbassano (Torino) (IT); Marco Biasiotto, Orbassano (Torino) (IT); Franco Tosco, Orbassano (Torino) (IT)

(21) Appl. No.: 14/365,919

(22) PCT Filed: Oct. 22, 2012
(86) PCT No.: PCT/IB2012/055802

§ 371 Date: Jun. 16, 2014

(30) Foreign Application Priority Data
Dec. 14, 2011 (EP) 11193468.3

(51) Int. Cl. B60J 5/04

(52) U.S. Cl. CPC B60J 5/0463; B60J 5/045; B60J 5/0416; B60J 5/0415; B60J 5/0484
USPC 296/146.6

(57) ABSTRACT

A motor-vehicle door comprises a structure including an inner panel (3), a carrier (5) fixed to the inner panel (3), for supporting a plurality of auxiliary members of the door, and a trimming panel (6, 7) which covers the carrier (5) and the inner panel (3) on the inner side of the door. The carrier (5) is made of fibre-reinforced synthetic material and it is rigidly connected to the inner panel (3) and it is configured to also serve as a structural reinforcement for said inner panel. The carrier (5) also has at least one portion (50, 52) exposed to view, not covered by said trimming panel (6, 7) and having a structure and a configuration such to directly serve the function of trimming panel at the exposed portions thereof. In a variant, the inner panel is constituted by a quadrangular framework constituted by one or more C-section elements defining an upper crosspiece, a lower crosspiece and two uprights which connect the ends of said crosspieces to each other. An outer panel (4) having a structure (40) configured to absorb impact energy, in particular a honeycomb-like structure, is provided for in this case.

The present invention refers to the motor-vehicle doors industry and it regards an innovative door architecture.

The object of the present invention is to provide a motor-vehicle door structure that is robust and capable of guaranteeing the utmost safety of the driver and passengers in case of impact, simultaneously being considerably light and capable of guaranteeing extremely easy and quick manufacture, assembly and maintenance operations.

According to the main characteristic thereof, the door according to the invention comprises:

a structure including an inner panel and an outer panel for completion and trimming,

a carrier fixed to the inner panel and carrying a plurality of auxiliary members of the door, and

a trimming panel which covers the carrier and the inner panel on the inner side of the door,

said door being characterised in that the carrier is made of fibre-reinforced synthetic material, it is rigidly connected to the inner panel and it is configured to also serve as structural reinforcement of said inner panel.

According to a further preferred characteristic, the carrier of the door according to the invention has at least one portion exposed to view, not covered by said trimming panel and having a structure and a configuration such to directly serve the function of trimming panel at the aforementioned exposed portions.

Due to the aforementioned characteristics, the structure of the door according to the invention is constituted by a small number of components, it is lighter with respect to doors of this type made according to the known art and it guarantees both a high robustness as well as easy and quick manufacture and assembly operations.

An alternative embodiment is characterized in that:

the inner panel is a framework comprising a U-shaped structure constituted by at least one profiled metal element defining at least one lower crosspiece and two uprights having the lower ends connected to the ends of said lower crosspiece, and in that:

an outer panel having a structure, for example of the honeycomb type, configured for absorbing impact energy, is fixed to the inner panel.

This second embodiment also reveals advantages in terms of construction simplicity and lightness, in terms of safety for the passengers in case of an impact, as well as in terms of easy and quick door assembly and maintenance operations.

Now, the invention will be described with reference to the attached drawings, provided purely by way of non-limiting example, wherein:

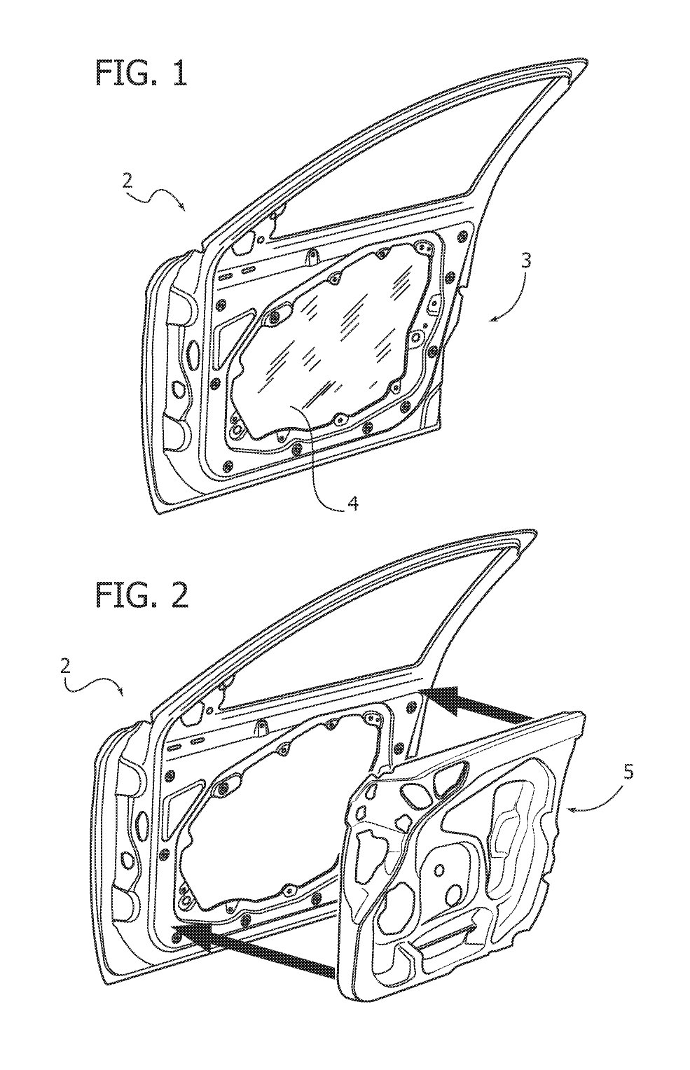

FIGS. 1-5 are perspective views showing the different assembly steps of a first embodiment of the door according to the invention,

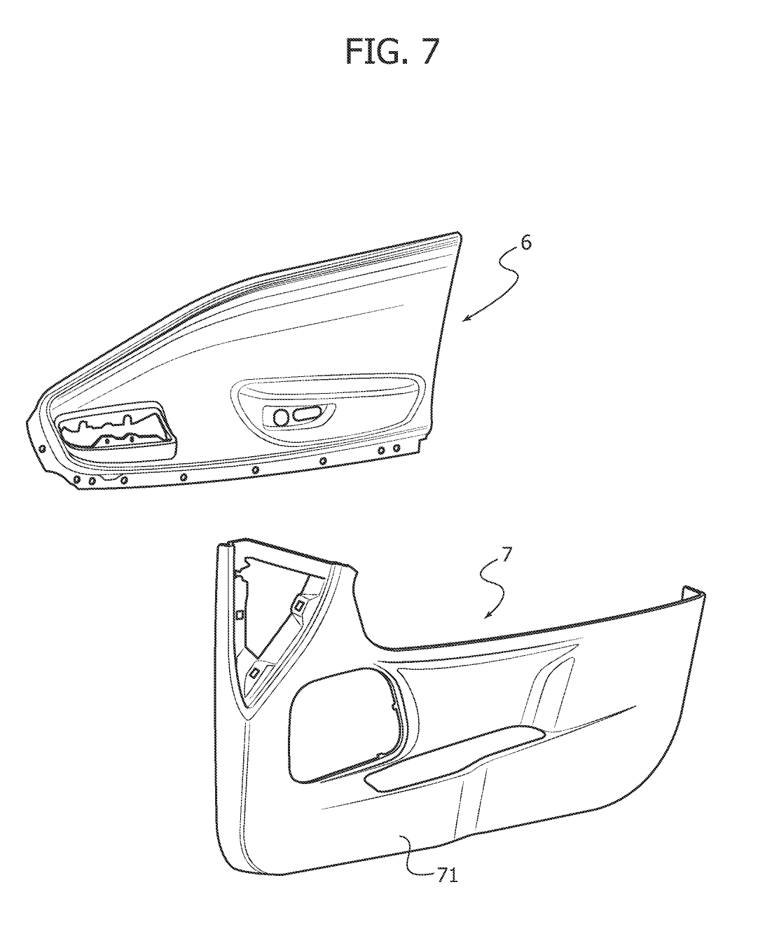

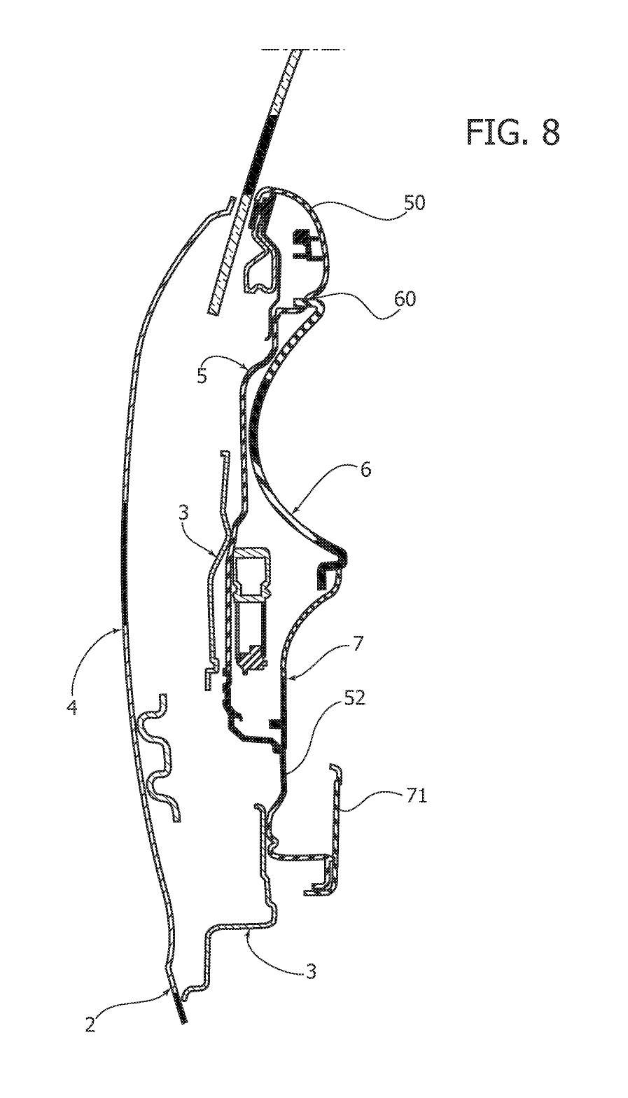

FIGS. 6, 7 are views of some of the components of the door of FIGS. 1-5,

FIG. 8 is an enlarged scale and sectional view in a plane perpendicular to the general plane of the door of FIGS. 1-7,

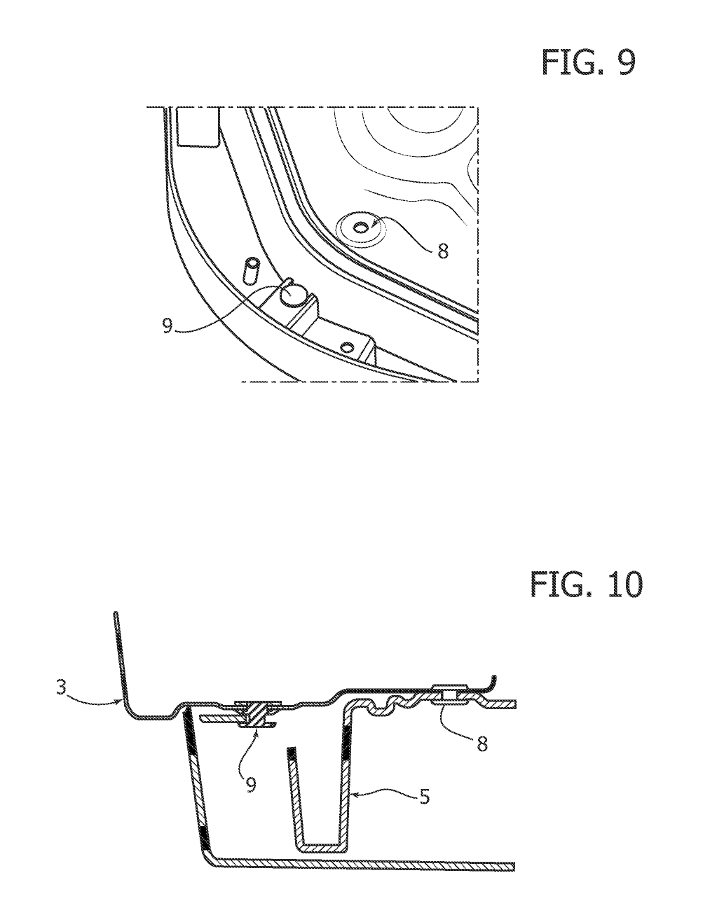

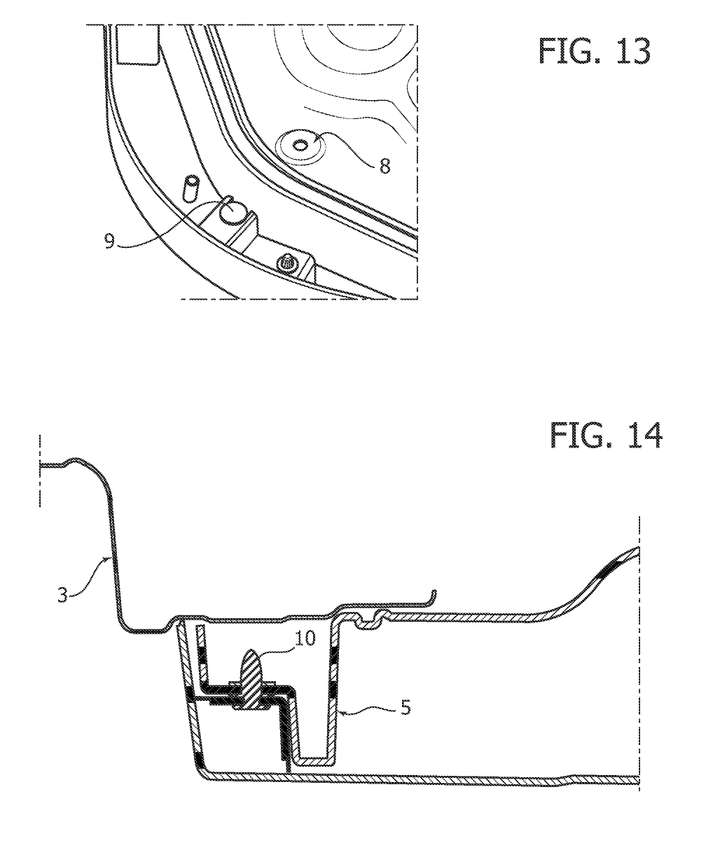

FIGS. 9-14 are detail perspective views and sectional views of some details regarding the connection between the various elements that form the door according to the invention, and

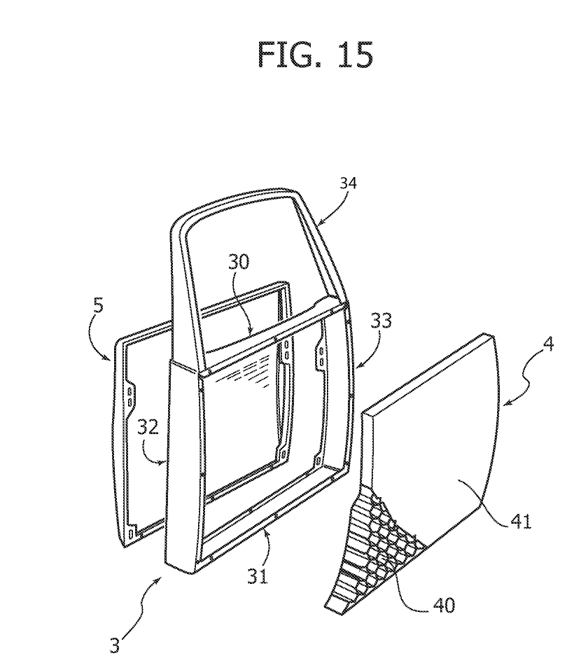

FIG. 15 is a schematic perspective view of a second preferred embodiment of the door according to the invention.

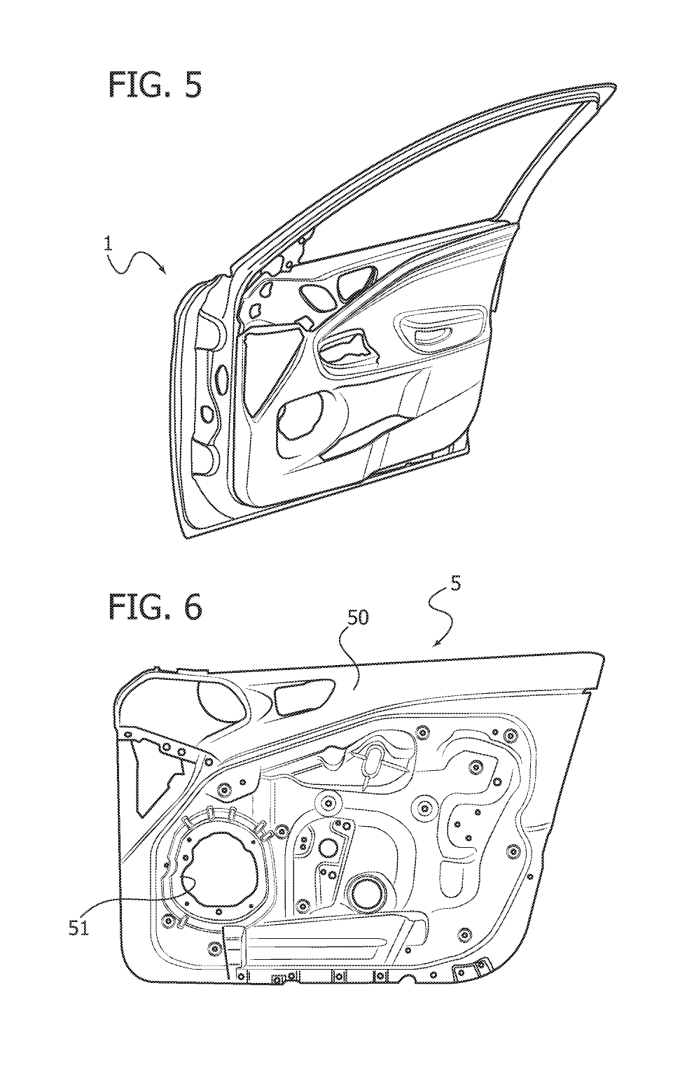

FIG. 5 of the attached drawings shows—in perspective view—a first embodiment of a vehicle side door provided according to the principles of the present invention. In such figure, the door is indicated in its entirety with reference number 1. In the case of the illustrated example, the door 1 first and foremost comprises a metal sheet structure 2 (see FIG. 1) comprising an inner panel 3 and an outer panel 4 rigidly connected to each other, typically by means of welding.

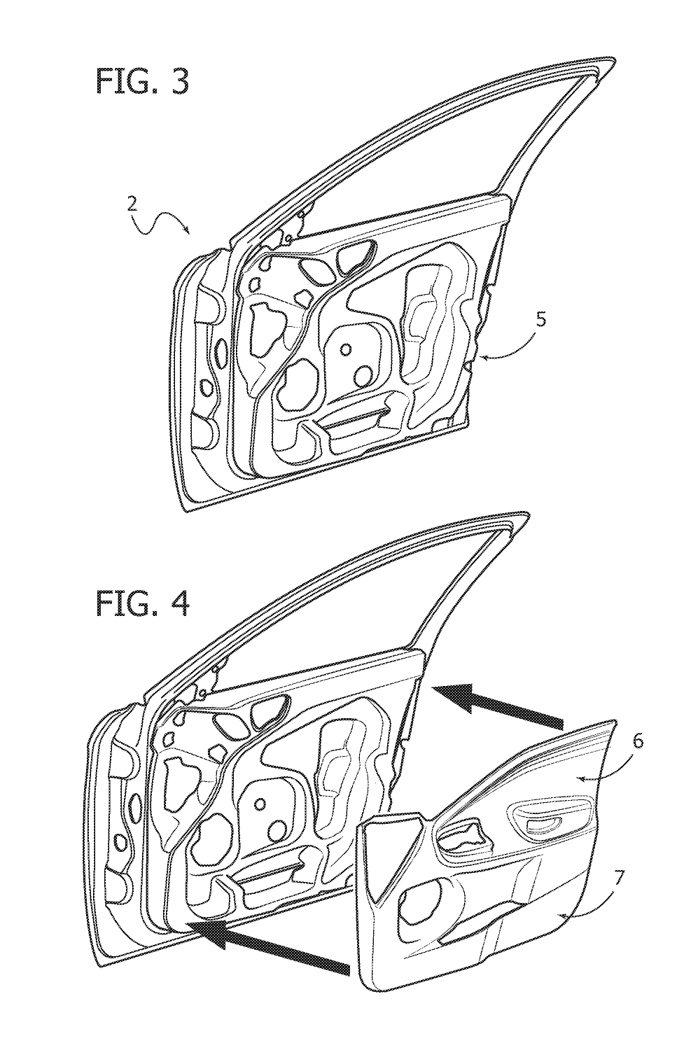

As observable in FIG. 2, a carrier 5 made of fibre-reinforced synthetic material, typically glass fibre but possibly even natural fibres such as juta, kenaf, etc, is fixed to the metal sheet structure 2, on the inner side thereof. The first function of the carrier 5 is to support a plurality of accessory members and devices of the door (such as for example a speaker, a power window or any other device). FIG. 2 shows the metal sheet structure 2 and the carrier 5 in exploded view, while FIG. 3 shows such components assembled to each other. As observable in FIG. 4, after positioning the carrier 5, the inner side of the door is closed with a an inner trimming structure constituted by two synthetic material panels 6, 7 arranged one on the other. FIGS. 6, 7 show the carrier 5 and the trimming panels 6, 7 respectively.

As clearly observable in FIG. 6, as well as in the section of FIG. 8 the carrier 5 has a portion 50 extending along the lower edge of the window and which is exposed to view, such portion 50 having a structure and a configuration such to directly serve the trimming function at such area. In order to guarantee the required aesthetic characteristics, the carrier 5 is manufactured using the technique that provides for two simultaneous injection moulding operations, one for the part 50, where the material is talc-filled polypropylene, and the other for the part underlying the portion 50, where the material is glass-fibre-filled polypropylene. The moulding of both the exposed portion 50 and the part underlying the portion 50 shall also be provided for using a single glass-fibre-filled plastic material.

In FIG. 6, the hole 51 obtained in the carrier 5 serves as a seat for mounting a speaker.

As observable also in FIG. 8, the carrier 5 also has a portion 52 exposed to view, which defines the inner wall of a pocket of the door, whose outer wall 71 is defined by the trimming panel 7. In the embodiment illustrated herein, the trimming panel 6 is for example made of the material referred to as “woodstok”, while the trimming panel 7 is made of talc-filled polypropylene. In case of use of woodstok, a reinforcement (not illustrated) is preferably used for fixing the panel 6 to the carrier 5. Alternatively, the panel 6 may be made of thermoformed synthetic material, using the “one-shot back injection” technique. No reinforcement is required in this case.

The connections of the various components indicated above to each other may be obtained through any known method, for example through a “Pinetto” fastener.

In a variant, the panels 6,7 are integrated in a single panel that can be obtained by means of a single thermoforming step.

The carrier 5 can be fixed to the inner panel 3 preferably using screws and/or rivets, preferably also with the help anti-vibration pads.

FIG. 9 shows a rivet 8 and an anti-vibration pad 9.

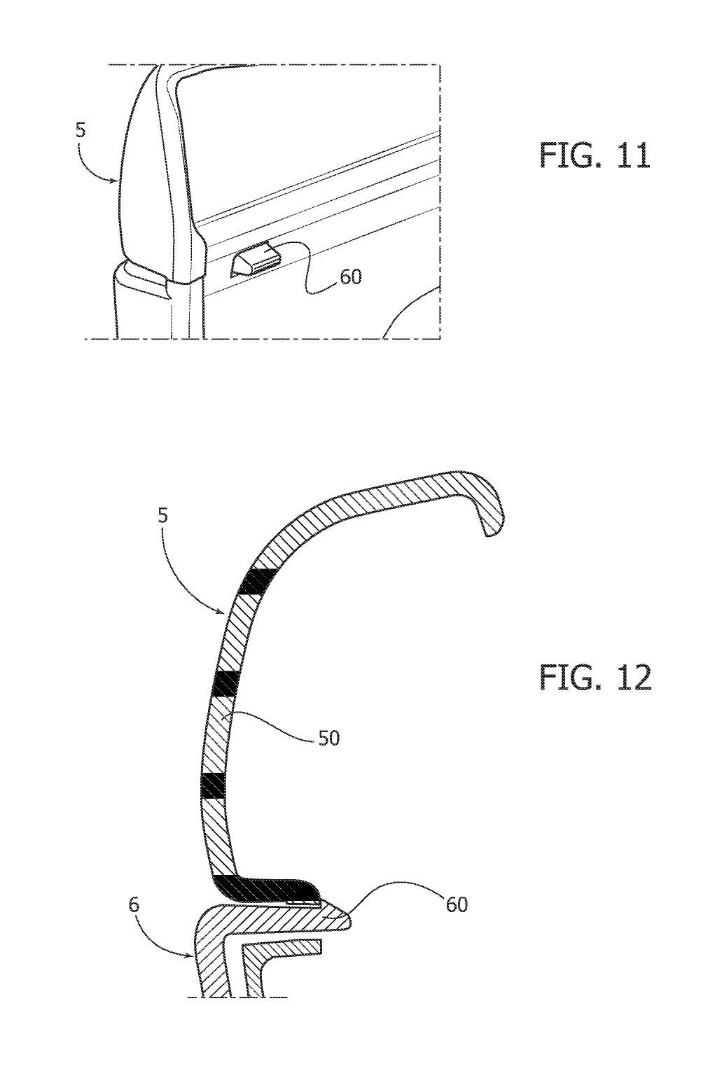

Still with reference to FIG. 8 and FIGS. 11, 12, the trimming panel 6 has—along the upper edge thereof—teeth 60 which are snap-received within corresponding openings obtained by moulding in the structure of the carrier 5.

FIGS. 13, 14 illustrate a variant in which, besides the rivets 8 and the anti-vibration pads 9 used for fixing the carrier 5 on the inner panel 3, Pinetto fasteners 10 are used for fixing the trimming panels 6, 7 to the carrier 5.

FIG. 15 of the attached drawings shows a second embodiment of the invention, in which the inner panel 3 of the door comprises a structure made of metal sheet constituted by one or more profiled metal elements connected to each other defining a continuous beam which in the illustrated example forms a quadrangular framework, with an upper crosspiece 30, a lower crosspiece 31 and two uprights 32, 33. In the case of a door with frameless window, the inner panel is limited to the structure described above. In the case of a window with frame, an auxiliary structure 34 defining the two vertical sides and the upper side of the window is fixed on the upper crosspiece 30. More generally, the inner panel 3 at least comprises the lower crosspiece 31 and the two uprights 32,33. The upper crosspiece may be part of the window framework 34, in cases where such framework 34 is provided for. The crosspiece 31 and the uprights 32,33 may be defined by a single section folded by rolling. The drawings show a C-shaped section, but more generally the shape of the section corresponds to that of the edge of the motor vehicle door compartment with which the door should be coupled, so as to guarantee perfect coupling with the sealing gaskets and a better contact in case of lateral impact (if the door and edge of the door compartment are not well coupled during the lateral impact the door could move beyond the lower side member of the body and project into the compartment).

In the embodiment illustrated in FIG. 15, on the inner side of the inner panel 3 there is mounted a single panel 5 serving as a carrier for supporting the accessory members of the door and incorporating—in a single piece—also the trimming panel on the inner side of the door. The panel 5 is preferably made of fibre-reinforced synthetic material.

The upper framework 34 shall be assembled on the carrier 5 on which the windows, guides and the power window motor shall be mounted: this allows performing all adjustments a component off-line and in addition, the movement of the glass shall be guided by components closely connected to each other. The structural carrier 5 and framework 34 shall constitute a single element in which the glass slides. This ensemble will then be assembled to the inner panel 3 ending up forming, with the outer panel, the complete door. With this architecture, the inner panel and outer panel do not contribute to the movement of the glass hence further adjustment shall not be required.

On the outer side, the door is closed with an outer panel 4 rigidly connected to the inner panel defined by the element 3 and having a structure made of reinforced synthetic material, or made of metal material or composite material, having a configuration adapted to absorb impact energy, preferably a honeycomb configuration.

An outer cover 41, which can be made of metal material or synthetic material and can be made in a single piece with the structure 40 or separate with respect thereto is applied to the structure 40.

In the preferred embodiment, the honeycomb configuration of the structure 40 has deep meshes which develop from one face of the panel 4 to the other, to absorb the impact energy. Such structure allows avoiding the use, in the door of FIG. 15, of an anti-intrusion reinforcement bar so as to obtain a weight advantage and an increase of resistance to impact. In case of lateral impact there is an energy absorption distributed over the entire panel 4 while in the conventional solutions impact energy is mainly absorbed by the anti-intrusion bar which is positioned, for various reasons, solely in lower part of the door. Furthermore, a rigid outer panel transfers—more timely—the incipient impact signal to the impact sensors thus allowing a quicker and more efficient intervention of the active safety systems.

In case of a monolithic panel incorporating the structure 40 and the cover 41, the material the panel is made of should combine the impact resistance and machinability characteristics (for example it should be suitable for painting). Regarding painting, the door with the outer panel made of plastic may be more applicable to vehicles in which, for example, the mudguards are also made of plastic. Thus the doors could be painted off-line as done for bumpers and plastic mudguards.

The variant with structure 40 and cover 41, both made of metal, may be obtained through non conventional manufacturing methods in the motor vehicle door construction industry, such as for example electrical discharge machining or die-casting, so as to obtain the alveolar structure 40.

Generally, an outer door panel obtained using the aforementioned technologies may have differentiated rigidity depending on the area (for example varying the density of the cells or the thickness thereof). Thus the central strip of the door could be stiffened so as to resist to lateral impacts and lighten the remaining part so as not to make the entirety heavy.

The alveolar structure with variable rigidity may also integrate other functions besides the anti-intrusion ones. Patches made of different material with rigidity function are glued on the conventional door panels; in other cases, this function is carried out by a further stiffening bar. The addition of glued patches also has the purpose of improving the acoustic behaviour of the door panel. All these functions may be met through an accurate design of the alveolar structure varying the wall thickness, depth, width and shape of the cells.

The door architecture illustrated in 15 allows a different kind of door assembly and maintenance, given that the panel 4 could be the last component to be assembled and the maintenance operations on the various accessory members present within the door could thus be carried out from the outer side of the door, after demounting the panel 4.

The assembly of the various components (carrier, inner panel and outer panel) may be obtained through conventional methods such as bolted joints, welding, gluing, plastic rivets etc.

The maintenance of the components (power windows, locks, handles etc) definitely must be guaranteed hence the carrier must be removable. The outer panel could be glued (greater structural rigidity) or fastened (demounting option with the possibility of carrying out maintenance operations on the accessories from outside).

The structural carrier plus inner panel plus outer structural panel form, with respect to the present invention, a closed structure in which all components contribute to the rigidity of the door thus reducing the weight thereof.

Obviously, without prejudice to the principle of the invention, the construction details and the embodiments may widely vary with respect to what has been described and illustrated purely by way of example, without departing from the scope of protection of the present invention.

1. Motor-vehicle door, comprising:
a structure including an inner panel (3) and an outer panel,
a carrier (5) fixed to the inner panel (3) and carrying a plurality of auxiliary members of the door, and
a trimming panel (6, 7) which covers the carrier (5) and the inner panel (3) on the inner side of the door,
said door being characterised in that the carrier (5) is made of fibre-reinforced synthetic material, it is rigidly connected to the inner panel (3) and it is configured to also serve as a structural reinforcement of said inner panel (3).

2. Door according to claim 1, characterised in that said carrier (5) has at least one portion (50, 52) exposed to view, not covered by said trimming panel (6, 7) and having a structure and a configuration such to directly serve the function of trimming panel at the exposed portions (50, 52) thereof.

3. Door according to claim 2, characterised in that said carrier (5) has an exposed portion (50) defining the inner surface of the door along the lower edge of the window.

4. Door according to claim 3, characterised in that said carrier (5) has an exposed portion (52) defining an inner wall of a pocket formed on the inner side of the door.

5. Door according to claim 1, characterised in that:
the inner panel (3) is a framework comprising a U-shaped structure constituted by at least one profiled metal element (30, 31, 32, 33) defining at least one lower crosspiece (31) and two uprights (32, 33) having the lower ends connected to the ends of said lower crosspiece (31), and in that:
an outer panel (4) having a structure (40) configured to absorb impact energy is fixed to the inner panel (3).

6. Door according to claim 5, characterised in that said lower crosspiece (31) and said uprights (32,33) are part of a single folded profiled element.

7. Door according to claim 5, characterised in that said inner panel (3) also comprises a window framework (34) fixed above said U-shaped framework (31,32,33).

8. Door according to claim 7, characterised in that said inner panel (3) comprises an upper crosspiece (30) which connects the upper ends of said uprights (32, 33) and which is part of said window framework (34) or said framework including the lower crosspiece (31) and the uprights (32, 33).

9. Door according to claim 5, characterised in that the framework constituting the inner panel (3) also comprises an upper crosspiece (30), which connects the upper ends of said uprights (32,33) to each other.

10. Door according to claim 5, characterised in that said at least one profiled metal element constituting said internal inner panel (3) has a section corresponding to the motor vehicle door compartment section with which the door should be coupled.

11. Door according to claim 5, characterised in that said carrier is incorporated in a single piece in said inner trimming panel (5).

12. Door according to claim 5, characterised in that said outer panel (4) has said structure (40), made of plastic material or metal material, configured to absorb impact energy and an outer cover for said structure, made of plastic material or metal material and made in a single piece with said structure (40) or separate with respect thereto.

13. Door according to claim 5, characterised in that said outer panel (4) has a honeycomb structure (40) configured to absorb impact energy.

14. Door according to claim 13, characterised in that the honeycomb structure (40) comprises different portions with differentiated rigidity.

15. Door according to claim 14, characterised in that the portions of the honeycomb structure (40) with different rigidity are differentiated from each other in terms of wall thickness and/or depth and/or width and/or shape of the honeycomb cells.
